(19) United States
(12) Patent Application Publication
(10) Pub. No.: US 2022/0283932 A1
(43) Pub. Date: Sep. 8, 2022

(54) FRAMEWORK THAT ENABLES ANYTIME ANALYSIS OF CONTROLLED EXPERIMENTS FOR OPTIMIZING DIGITAL CONTENT

(71) Applicant: Adobe Inc., San Jose, CA (US)

(72) Inventors: David Arbour, San Jose, CA (US); Ritwik Sinha, San Jose, CA (US); Ian Waudby-Smith, San Jose, CA (US); Aaditya Ramdas, San Jose, CA (US)

(21) Appl. No.: 17/192,320

(22) Filed: Mar. 4, 2021

(51) Int. Cl. G06F 11/36; G06F 16/958; G06F 8/77

(52) U.S. Cl. CPC G06F 11/3688; G06F 16/958; G06F 8/77

(57) ABSTRACT

A computer-implemented method includes instantiating a framework configured to optimize a metric of interest for a website based on interactions by participants with instances of a website in a controlled experiment. The instances of the website include one of two variants of digital content. Test data including an estimate of an effect on the metric of interest is generated based on the interactions. A sequence of confidence intervals is dynamically generated while the controlled experiment is ongoing. The true effect and the estimate effect on the metric of interest are both bounded by the sequence of confidence intervals throughout the controlled experiment. As such, an anytime analysis with anytime-valid test data is enabled while the controlled experiment is ongoing.

### TECHNICAL FIELD

The disclosed technology relates to a framework that enables anytime analysis of a controlled experiment for optimizing digital content, particularly in the context of A/B experiments to optimize a website for a metric of interest.

### BACKGROUND

A method for optimizing digital content on websites includes A/B testing (also known as “bucket testing” or “split-run testing”). In practice, two versions (A and B) of a single variable are compared, which are identical except for one variation that might affect a user's behavior. A/B tests are useful for understanding user engagement and satisfaction of online features, such as a new feature or product. Social media sites like LinkedIn®, Facebook®, and Instagram® use A/B testing to make user experiences more successful and as a way to streamline services. In another example, Adobe Target™ is an online service that implements A/B testing for optimizing design, content, and navigation of websites.

Today, A/B tests are being used to run more complex experiments, such as network effects when users are offline, how online services affect user actions, and how users influence one another. Companies rely on test data from A/B tests to understand growth, increase revenue, and optimize customer satisfaction. However, A/B testing is computationally expensive and slow to converge to valid results. As such, A/B testing causes delays to deploy websites and, moreover, requires redoing each A/B test whenever a variable under consideration has changed, which further wastes time and resources.

### SUMMARY

The disclosed framework enables anytime analysis of a controlled experiment. In one example, a platform that implements the framework allows a user to optimize digital content for a website by conducting an A/B test. The user can view results of the A/B test while the A/B test is ongoing in order to discover which variant of a website is more likely to have a desired effect on a metric of interest. In one example, the framework extends common techniques in an A/B testing protocol with sequential confidence intervals that account for past randomness. As a result, the framework allows the user to (a) analyze results in anytime, (b) start an experiment without worrying about how many samples are needed to detect an effect, and (c) continue the experiment despite new test data becoming available.

### BRIEF DESCRIPTION OF THE DRAWINGS

Embodiments of the present technology will be described and explained through the use of the accompanying drawings.

FIG. 1 is a block diagram that illustrates a network environment including an optimization platform.

FIG. 2 is a block diagram that illustrates a computing device that enables anytime data analysis of controlled experiments for optimizing digital content.

FIG. 3 illustrates a flowchart that illustrates a process for enabling anytime data analysis of a controlled experiment for optimizing digital content.

FIG. 4 is a block diagram that illustrates an example of an A/B test.

FIG. 5 is a graph that shows confidence intervals relative to a quantity of participants in an A/B test.

FIG. 6 is a graph that illustrates the cumulative miscoverage probabilities for fixed-time and sequential confidence intervals.

FIG. 7 is a graph of confidence interval sequences relative to a sample set of participants in an A/B test.

FIG. 8 is a block diagram illustrating an example of a computing system in which at least some operations described herein can be implemented.

Various features of the technologies described herein will become more apparent to those skilled in the art from a study of the Detailed Description in conjunction with the drawings. Embodiments are illustrated by way of example and not limitation in the drawings, in which like references may indicate similar elements. While the drawings depict various embodiments for the purpose of illustration, those skilled in the art will recognize that alternative embodiments may be employed without departing from the principles of the technologies. Accordingly, while specific embodiments are shown in the drawings, the technology is amenable to various modifications.

### DETAILED DESCRIPTION

Introduced here is a framework for conducting controlled experiments (e.g., A/B tests) to optimize digital content. The output of a controlled experiment includes values for an effect on a metric of interest. A value that is within a confidence interval is deemed valid. A confidence interval refers to the range of values so defined that there is a specified probability that the true value lies within it. That is, the interval has an associated confidence level that the true value is in the proposed range.

In a typical A/B test, a platform collects data of a metric of interest for a period during which participants of a predetermined sample size are randomly given experience A or B (n_{A} and n_{B} participants). An experimenter must wait for the predetermined number of participants to experience the A/B variants before obtaining results within a given statistical confidence interval. In practice, the sample size is determined by using a power calculation, which is a measure of how many participants are required to obtain desired results. The time period that the experimenter must wait is proportional to the predetermined sample size.

The platform of the typical A/B test computes a (1−α) fixed-time confidence interval, CIₙ based on n=n_{A}+n_{B} observations guaranteeing that if the experiment were repeated many times, CIₙ would contain the true metric of interest in 100(1−α) % of the experiments. This translates to saying with high confidence that the metric of interest is in the computed confidence interval, CIₙ. However, this high-confidence conclusion is limited to that particular n. If new data are collected, the follow-up confidence intervals, CIₙ₊₁, CIₙ₊₂, . . . do not have probabilistic guarantees and cannot be used to make high-confidence conclusions. Hence, a new test is required to include the new data.

An experimenter of the typical A/B test could theoretically try to analyze a metric of interest before the test is complete; however, that could cause overconfidence in errant results that are not within the fixed-time confidence interval. To safeguard against having confidence in errant results, platforms prevent experimenters from looking at results until only after the A/B test concludes. Moreover, with a fixed-time confidence interval, inferences cannot be updated if new data are collected for an experiment; nevertheless, experimenters might still choose to do so because the idea seems reasonable.

The disclosed framework removes the restrictions of typical A/B tests by dynamically generating a sequence of confidence intervals that is valid at any time during the experiment. In other words, values of an effect on a metric of interest are always within the sequence of confidence intervals such that the experimenter has confidence that the results are always valid. Hence, the sequence of confidence intervals allows for anytime interactions or analysis by the experimenter while the experiment is ongoing (e.g., before the experiment is complete) because results are always bounded by the sequence of confidence intervals throughout the controlled experiment.

For example, a platform that implements the disclosed framework can conduct an A/B test for a website and allow anytime (e.g., real-time) analysis of the effects of the A/B test. Hence, a user of the platform can perform sequential analysis or obtain anytime-valid results before the A/B test has finished. In contrast, typical A/B testing requires waiting until after a predetermined number of iterations before obtaining statistically valid results. As a result, the experimenter cannot infer a valid effect of variants A/B on a metric of interest until the A/B test is complete, which could, for example, delay deploying a website with optimized digital content that achieves a desired effect.

To aid in understanding, the disclosed framework is described in the context of digital content optimization for a website; however, the framework could be applied in other contexts for optimizing other digital data. Moreover, the examples described here mainly refer to A/B testing; however, the framework generally applies to controlled experiments where digital content is optimized for a metric of interest. Examples of a metric of interest in this context include a click-through event, conversion rate, or a continuous metric like time on a webpage or revenue. An experimenter that wants to optimize a website for these metrics oftentimes uses a platform that runs A/B tests to discover which variant A/B of a website is more likely to improve or maximize metrics.

Thus, the framework leverages an “anytime-valid inference” to extend typical A/B testing protocols for a sequential analysis. This extension allows an experimenter to (a) analyze results of an A/B test at any time including real-time, (b) conduct an A/B test without worrying about how many samples are needed to detect an effect that is valid, and (c) continue the experiment for any reason in the event that new data becomes available.

If sample sizes are sufficiently large, the conclusions made from A/B tests are always valid regardless of how one chooses to start, stop, or continue an experiment. As such, data analysis is not limited to particular times (e.g., after concluding an A/B experiment); instead, a platform that implements the framework can perform data analysis “on-the-fly” while new data are collected. Moreover, an A/B experiment can be stopped whenever the appropriate amount of data has been collected rather than needing to predetermine a sufficiently large sample size at the outset. Notably, it is difficult to predetermine how large of a sample size is required to detect a desired effect because that depends on the size of the effect. However, using the disclosed framework, the length (e.g., sample size) of the experiment adapts to the size of the effect.

To enable the anytime analysis, the framework continuously updates a sequence of confidence intervals to account for randomness of test data such that a valid conclusion of an effect on a metric of interest is obtained anytime during the test. In one example, the participants in an A/B test include visitors to a website. The participants are randomly selected to experience variants A/B of digital content on the website. The estimate effect of experiencing variants A/B on a metric of interest (e.g., a click-through, where the A/B test includes variants to increase the click-through) is measured. In an implementation of the framework, the true mean (e.g., actual effect) always lies within the confidence intervals, which is not necessarily true in prior A/B tests (until a test concludes).

### Optimization Platform

An optimization platform that implements the disclosed framework can provide a service for experimenters to optimize digital content including media (e.g., images, videos) of websites. An experimenter can liberally monitor a controlled experiment and obtain statistically valid results that are within confidence intervals throughout the controlled experiment. For example, an experimenter can utilize the platform to perform a controlled experiment and obtain reliable test data before the experiment is complete, which is not possible with typical A/B tests. As such, the experimenter can avoid wasting time to obtain valid test data because the experimenter would not have to wait until a predetermined quantity of participants have completed the experiment. Further, the platform can reuse or introduce new test data to update the experiment without compromising the integrity of the test. Therefore, the platform removes the restrictions of typical A/B tests, which are at odds with the online nature of data collection and, which, when ignored, lead experimenters to be overconfident of errant results.

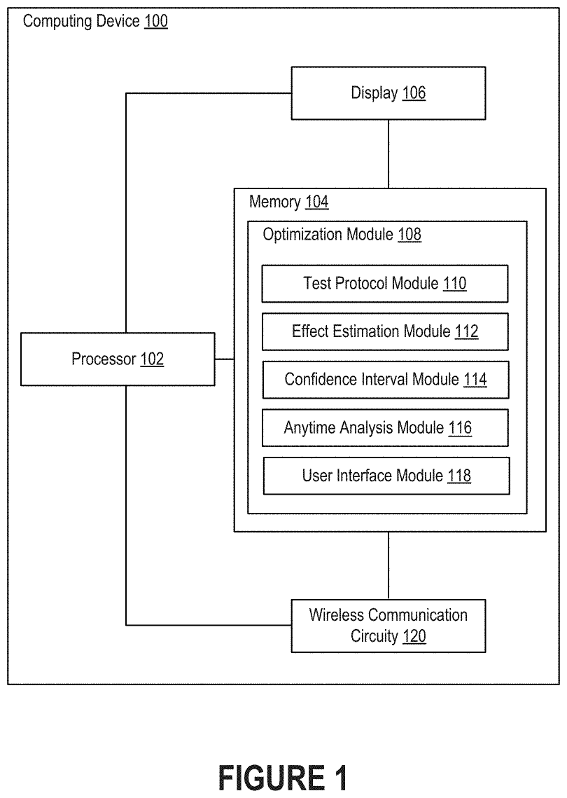

FIG. 1 is a block diagram that illustrates a computing device 100 that enables anytime data analysis of controlled experiments for optimizing digital content. The components shown in FIG. 1 are merely illustrative and well-known components are omitted for brevity. As shown, the computing device 100 includes a processor 102, a memory 104, and a display 106. The computing device 100 may also include wireless communication circuitry 120 designed to establish wireless communication channels with other computing devices. The processor 102 can have generic characteristics similar to general-purpose processors, or the processor 102 may be an application-specific integrated circuit (ASIC) that provides arithmetic and control functions to the computing device 100. While not shown, the processor 102 may include a dedicated cache memory. The processor 102 can be coupled to all components of the computing device 100, either directly or indirectly, for data communication.

The memory 104 may be comprised of any suitable type of storage device including, for example, a static random-access memory (SRAM), dynamic random-access memory (DRAM), electrically erasable programmable read-only memory (EEPROM), flash memory, latches, and/or registers. In addition to storing instructions which can be executed by the processor 102, the memory 104 can also store data generated by the processor 102 (e.g., when executing the modules of an optimization platform). The memory 104 is merely an abstract representation of a storage environment. Hence, in some embodiments, the memory 104 is comprised of one or more actual memory chips or modules.

An example of the display 106 includes a touch-enabled display or a non-touch-enabled display, in which case the computing device 100 likely also includes (or is connected to) an input device such as a keyboard. An example of the wireless communication circuitry 120 forms and/or communicate with a network for data transmission among computing devices, such as personal computers, mobile phones, and computer servers. The wireless communication circuitry 120 can be used for communicating with these computing devices or for connecting to a higher-level network (e.g., a LAN) or the Internet. Examples of wireless communication circuitry 120 include Bluetooth, Z-Wave, ZigBee, and the like. In some embodiments, the connection established by the wireless communication circuitry 120 can be bootstrapped by a near field communication (NFC) connection.

For convenience, the optimization module 108 may be referred to as a computer program that resides within the memory 104. However, as noted above, the optimization module 108 could be comprised of software, firmware, and/or hardware components implemented in, or accessible to, the computing device 100. In accordance with some embodiments of the framework, the optimization module 108 includes a test protocol module 110 (“test module 110”), an effect estimation module 112 (“estimation module 112”), a confidence interval module 114 (“confidence module 114”), a anytime analysis module 116 (“analysis module 116”), and a UI module 118. Similar to the optimization module 108, each of these modules can be implemented via software, firmware, and/or hardware. As shown, modules are parts of the optimization module 108. Alternatively, modules can be logically separate from the optimization module 108 but operate “alongside” it. Together, the modules enable anytime (e.g., real-time) analysis of a controlled experiment to optimize digital content of, for example, a website.

The optimization module 108 can obtain source data related to a test protocol and digital content. The source data could be acquired from the memory 104 upon receiving input indicative of a selection of a digital marketing campaign, participants, etc. Alternatively, the source data is acquired by the optimization module 108 responsive to determining that an experimenter has indicated an interest in initiating a controlled experiment related to a website or a digital marketing campaign.

The test module 110 establishes a controlled experiment for optimizing a metric of interest related to, for example, a website based on variants of digital content. Generally, the data is comprised of a protocol for testing the digital content presented on instances of a website for different participants. The test module 110 executes the test protocol by presenting one variant to a randomly selected subset of participants and another variant to another randomly selected subset of participants

The estimation module 112 generates test data including an estimate of an effect (e.g., positive, negative) on the metric of interest as the controlled experiment executes. For example, the estimation module 112 estimates the effect on a metric of interest based on bounded interactions (e.g., click-through, conversion) or unbounded interactions (e.g., time on website, frequency of visits).

The confidence module 114 determines a sequence of confidence intervals while the controlled experiment executes. The true effect on the metric of interest is bounded by sequence of confidence intervals. The confidence module 114 conditions a next confidence interval to account for past randomness occurring while executing the test protocol. The details for generating the sequential confidence intervals are described earlier and, as such, are not repeated here.

The analysis module 116 enables anytime analysis of test data (e.g., results) while the controlled experiment executes. That is, the analysis module 116 enables observation of a portion of total test data without pausing the controlled experiment. The test data can be updated on-the-fly while the experiment is executing, and the experiment is dynamically updated accordingly without compromising the validity of the results. In other example, an experimenter can pause the experiment to view ongoing results and then resume the experiment without compromising the integrity of the test data.

The UI module 118 can generate interfaces through which an experimenter can interact with the optimization module 108, view outputs produced by the aforementioned modules, etc. A visualization component could include information regarding estimates generated by the estimation module 112 or data output by the analysis module 116 and posted by the UI module 118 to a GUI presented on the display 106.

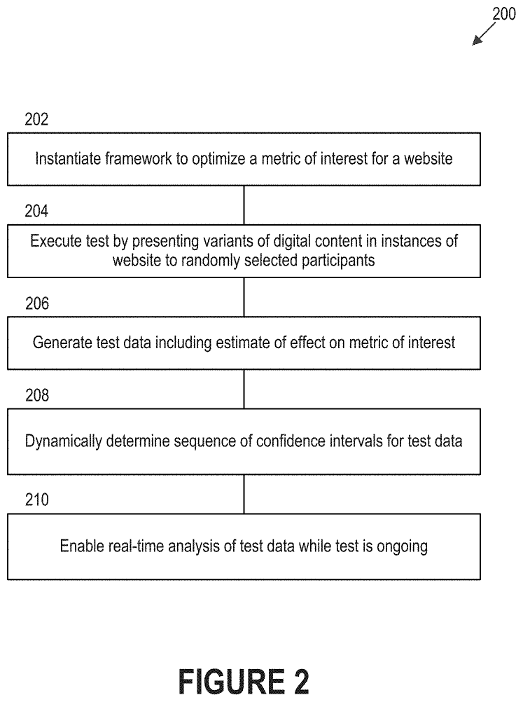

FIG. 2 is a flowchart that illustrates a process 200 for optimizing a metric of interest for a website based on a controlled experiment that enables anytime analysis of test data. The process 200 is performed by, for example, the computing device 100. For example, the optimization module 108, including the test module 110, estimation module 112, confidence module 114, analysis module 116, and/or UI module 118 can perform the process 200.

At 202, the optimization module 108 instantiates a framework configured to optimize a metric of interest for a website based on two variants of digital content included on instances of a website presented to participants of a controlled experiment (e.g., A/B test). For example, an experimenter can access an optimization service over a network to optimize a website for maximum click-throughs or conversion rates.

At 204, the test module 110 executes a test protocol causing each instance of the website to include one of the two variants of the digital content (e.g., A/B variants). The test protocol includes a controlled experiment that completes once all the participants interact with the instances of the website. In one example, the test protocol includes a predetermined quantity of participants to complete the controlled experiment. In another example, the test protocol includes an undetermined quantity of participants to complete the controlled experiment. Hence, a known quantity of participants for the controlled experiment is not required to obtain valid test data.

At 206, the estimation module 112 generates test data including an estimate of an effect on the metric of interest based on the interactions of the participants with the instances of the website. For example, the estimation module 112 estimates the effect based on bounded or unbounded interactions by the participants with the instances of the website including the variants of the digital content. Examples of bounded interactions include a click event, a conversion event, adding an item to a virtual cart, signing up for an email account, registering for an event, initiating a service event, or writing a comment. Examples of unbounded interactions include a time duration spent on the website, times between visits to the website, revenue, number of units bought, and numbers of pages clicked before purchasing a unit.

At 208, the confidence module 114 dynamically determines a sequence of confidence intervals with boundaries within which lies the true effect on the metric of interest throughout the controlled experiment. Specifically, a platform executes an algorithm that computes a (1−α) confidence sequence, Cₜ, Cₜ₊₁, Cₜ₊₂, . . . with a guarantee that if the experiment were repeated many times, every single one of the confidence intervals (Cᵢ)ᵢ₌₁^{∞} contains the true metric of interest in at least 100(1−α) % of repeated experiments. This translates to being able to say with high confidence that the metric of interest is in all of the computed confidence intervals over an infinite time horizon (e.g., the entire confidence sequence), no matter how many times the confidence interval is updated with new data.

To obtain the sequence of confidence intervals offering high-probability guarantees, the framework uses an approximation theory of stochastic processes to find that sample means are approximately a scaled Wiener process over an infinite time horizon, with the approximations getting arbitrarily strong as time progresses. Wiener processes are well-understood objects, as they stay within a known range over all time with high probability. Sample means being arbitrarily well-approximated by scaled Wiener processes for large samples thus yields an approximate range in which the sample mean lies over all time. Specifically, if data are observed over time, X₁, X₂, . . . Xₜ, Xₜ₊₁, . . . from a common distribution, then

$$\frac{1}{t} {\sum }_{i = 1}^{t} {X}_{i} \pm {\hat{σ}}_{t} \sqrt{\frac{2 ( t {ρ}^{2} + 1}{{t}^{2} {ρ}^{2}} ln ( \frac{\sqrt{t {ρ}^{2} + 1}}{α / 2} )} + o ( \sqrt{\frac{ln t}{t}} )$$

is a (1−α) confidence sequence for the mean of the Xᵢ variables. Here, \hat{σ}ₜ is the sample standard deviation based on the first t data points, and ρ² is a tuning parameter which allows the experimenter to tighten the confidence sequence at a particular time (e.g., smaller values correspond to a tighter sequence later on). The o(·) term signifies the error term that shrinks to zero faster than the first term. The significance here is that the approximation error shrinks to zero faster than the width of the confidence intervals. As such, the confidence intervals are valid for large t. In other words, as long as there are many participants enrolled in the A/B test, the approximations are strong.

Specifically, suppose X₁, X₂, . . . , Xₜ, Xₜ₊₁, . . . ˜^{iid}p are independent and identically distributed (iid) random variables from a common distribution p. Denote the mean of Xᵢ by μ. The framework aims to construct a confidence sequence (CS) for μ. Define the sample mean and sample standard deviation at time t:

$$\begin{matrix}{\hat{μ}}_{t} := \frac{1}{t} {\sum }_{i = 1}^{t} {X}_{i} & ( sample mean ) \\ {\hat{σ}}_{t} := \sqrt{\frac{1}{t} {\sum }_{i = 1}^{t} {X}_{i}^{2} - {\hat{μ}}_{t}^{2}} & ( sample standard deviation )\end{matrix}$$

For any ρ²>0 at any time t≥1, define the “margin” for any α∈(0,1):

$${m}_{t} ( {ρ}^{2} , α ) := \sqrt{\frac{2 ( t {ρ}^{2} + 1 )}{{t}^{2} {ρ}^{2}} ln ( \frac{\sqrt{t {ρ}^{2} + 1}}{α} )} .$$

Then as long as X₁ has at least three finite moments:

$${\hat{μ}}_{t} \pm {\hat{σ}}_{t} \cdot {m}_{t} ( {ρ}^{2} , \frac{α}{2} ) + o ( \sqrt{\frac{ln t}{t}} )$$

where the error term

$$o ( \sqrt{\frac{ln t}{t}} )$$

is asymptotically negligible when compared to the confidence sequence width, which scales like o

$$o ( \sqrt{\frac{ln t}{t}} ) .$$

This forms a (1−α)−CS for μ. That is, this is an approximate 95% confidence sequence for the mean μ, where \hat{μ}ₜ is the sample mean and \hat{σ}ₜ is the sample standard deviation. In other words, with probability of at least (1−α),

$$∀ t \geq 1 , \vert {\hat{μ}}_{t} - μ \vert \leq {\hat{σ}}_{t} \cdot {m}_{t} ( {ρ}^{2} , \frac{α}{2} ) + o ( \sqrt{\frac{ln t}{t}} ) .$$

Therefore, the approximation error of the confidence sequence shrinks at a faster rate than the margin. As such, the approximation is strong for large t . That is, the error is negligible for large samples.

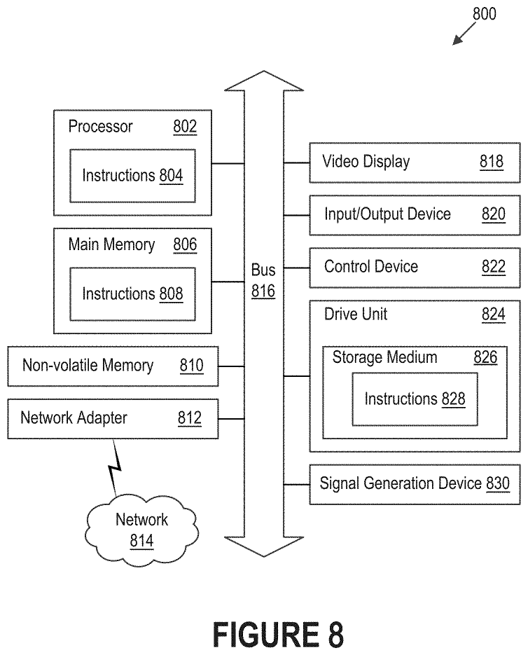

Thus, the sequence of confidence intervals is conditioned to account for past randomness of test data including variations related to participants to provide for always-valid inferences of the experiment. The confidence intervals could be further conditioned to improve test results. In one implementation, for example, any next confidence interval is adjusted based on a regression model as described with respect to FIG. 8.

The test protocol can be updated while executing the controlled experiment and determine a next confidence interval of the sequence based on the updated test protocol such that the true effect remains bounded by subsequent confidence intervals. An example includes adding participants to the controlled experiment. If doing so, the determination of the sequence of confidence intervals is adapted based on the additional participants without compromising the validity of the test data.

At 210, given that the true effect of the metric of interest is always bounded by the sequence of confidence intervals, the analysis module 116 enables anytime (e.g., real-time) analysis of the test data before the controlled experiment is complete. That is, the experimenter does not need to wait until the controlled experiment is complete to obtain valid test data. The estimate of the effect is bounded by the sequence of confidence intervals throughout the controlled experiment. For example, an experimenter can pause the controlled experiment, observe a portion of total test data, and resume the controlled experiment without compromising the validity of the test data. Hence, the framework can determine valid estimation including a positive effect or negative effect on the metric of interest before or after completing the controlled experiment.

In some examples, the process 200 is accessible to the experimenter through a GUI to input test parameters for the controlled experiment and view test data. For example, the UI module 118 can cause display of the GUI including a visualization of the test data, which is available to the experimenter before and after the controlled experiment is completed.

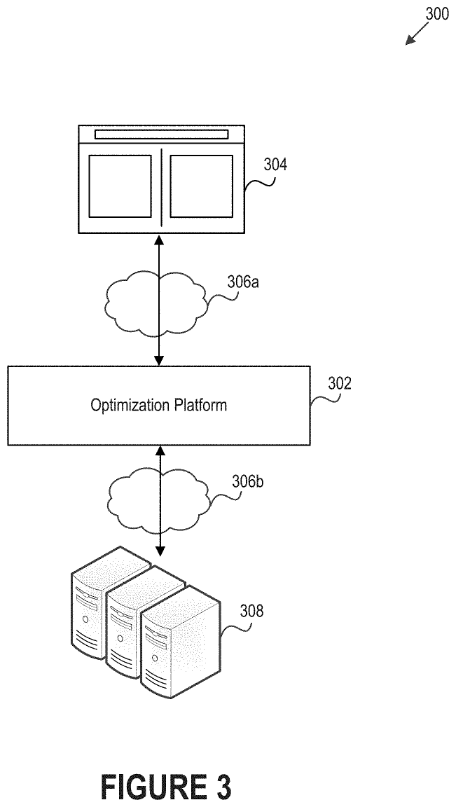

FIG. 3 is a block diagram that illustrates a network environment 300 including an optimization platform 302. The optimization platform 302 executes instructions to perform controlled experiments and enable anytime analysis of test data. The optimization platform 302 can include modules that operate to obtain source data for a controlled experiment, estimate an effect on a metric of interest for a website, dynamically generate confidence intervals, enable anytime analysis of test data, and control a user interface (UI) to present test data in real-time. The term “module” refers broadly to software components, firmware components, and/or hardware components. Accordingly, aspects of the optimization platform 302 could be implemented in software, firmware, and/or hardware.

As shown, users of the optimization platform 302 can interface with the optimization platform 302 via an interface 304. An example of the optimization platform 302 includes a service and/or software program through which experimenters can access analytics, media optimization, or content management products that may be useful in designing, implementing, and reviewing digital content for websites. In one example, the optimization platform 302 creates interfaces through which these services are deployed.

The test data for a controlled experiment is uploaded to and/or generated by the optimization platform 302. For example, an experimenter can access the optimization platform 302 and then select, via an interface 304 generated by the optimization platform 302, data related to a test protocol stored in a memory for A/B testing. As another example, an experimenter can access the optimization platform 302 and then identify, via an interface 304 generated by the optimization platform 302, a service responsible for promoting products online. In such a scenario, the optimization platform 302 may acquire source data from an advertising service (e.g., via an application programming interface).

As further shown, the optimization platform 302 resides in a network environment 300 and is connected to one or more networks 306a-b. The network(s) 306a-b can include personal area networks (PANs), local area networks (LANs), wide area networks (WANs), metropolitan area networks (MANs), cellular networks, the Internet, etc. Additionally or alternatively, the optimization platform 302 is communicatively coupled to computing device(s) over a short-range communication protocol, such as Bluetooth® or near-field communication (NFC).

The interface 304 is preferably accessible via a web browser, desktop application, mobile application, and/or over-the-top (OTT) application. Accordingly, the interface 304 is viewed on a personal computer, tablet computer, mobile phone, game console, music player, wearable electronic device (e.g., a watch or a fitness accessory), network-connected (“smart”) electronic device, (e.g., a television or a home assistant device), virtual/augmented reality system (e.g., a head-mounted display), or some other electronic device.

Some embodiments of the optimization platform 302 are hosted locally. That is, the optimization platform 302 resides on the computing device used to access the interface 304. For example, the optimization platform 302 may be embodied as a desktop application executing on a personal computer or a mobile application executing on a mobile phone. Other embodiments of the optimization platform 302 are executed by a cloud computing service operated by Amazon Web Services® (AWS), Google Cloud Platform™, Microsoft Azure®, or a similar technology. In such embodiments, the optimization platform 302 resides on a network-accessible server system 308 including one or more computer servers. The computer servers 308 can include different types of data (e.g., data related to digital content), user information (e.g., profiles and credentials), and other assets. Those skilled in the art will recognize that the modules of the optimization platform 302 could also be distributed amongst a computing device and a network-accessible server system.

Embodiments are described in the context of network-accessible interfaces; however, skilled persons will recognize that the interfaces need not necessarily be accessible via a network. For example, a computing device may execute a self-contained computer program that does not require network access. Instead, the self-contained computer program may download assets (e.g., data regarding digital content as part of a digital marketing campaign, data regarding A/B test results, test protocols, and processing operations) at a single point in time or on a periodic basis (e.g., weekly, daily, or hourly).

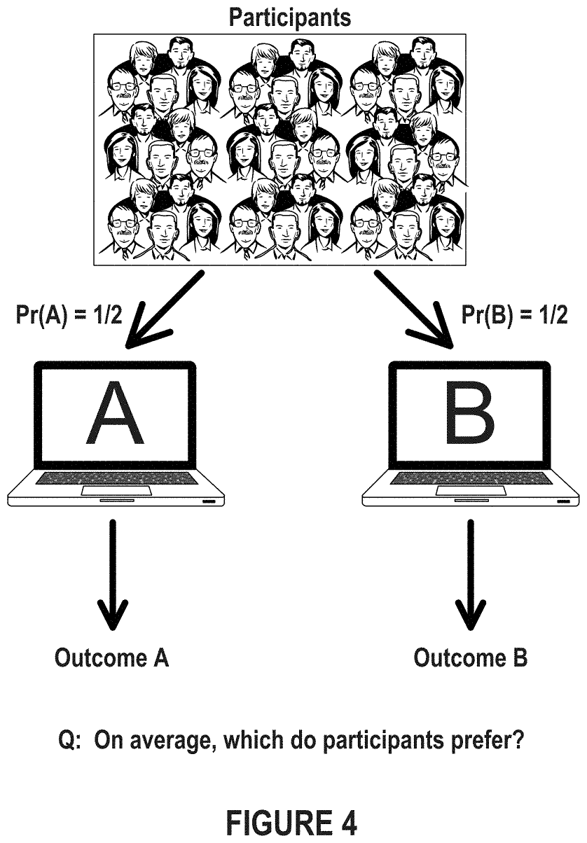

FIG. 4 is a block diagram that illustrates an example of an A/B test. In one example, the A/B test is processed by a platform (e.g., optimization platform 302) that is accessible by an experimenter to optimize digital content for a website. A power calculation is performed to determine an estimate of a quantity of participants required to obtain valid results (within a confidence interval). The platform selects random samples of participants to experience variants A/B of digital content and compares the effect of the variants A/B on a metric of interest.

From a statistical perspective, the probabilities of outcomes A and B are equal. The platform observes a participant's responses to variants A/B to determine which variant is more effective at having a desired effect. Thus, an A/B test is conducted to determine whether, on average, a user prefers A or B. The objective is to determine an average difference in the metric of interest between experiences A and B. This difference is the “parameter of interest.” As such, the platform allows the experimenter to make conclusions about which variant provides, for example, a maximum click-through rates of users.

Specifically, an experimenter is interested in the “average treatment effect,” which is the difference of average outcomes. For a large number of participants, based on the central limit theorem, the platform can determine a confidence interval for the average treatment effect. However, in typical A/B testing, the confidence interval is not guaranteed as the experimenter observes new data while the A/B test is being conducted. Hence, A/B testing is slow to converge because a platform needs to wait for responses from a predetermined sample of participants over a time period and must redo an A/B test whenever one variable under consideration is changed (e.g., new participants).

Prior improvements fail to provide anytime analysis of an ongoing A/B test. For example, one improvement includes performing sequential A/B tests by using a mixture sequential probability ratio test. In this solution, however, the probabilistic guarantees required for online A/B testing only hold when data are from a single-parameter exponential family. In contrast, the disclosed framework provides probabilistic guarantees for online A/B testing in (a) situations where few assumptions about the data are required, (b) to handle multi-parameter estimation, and (c) works for novel regression problems such as maximum-likelihood and M-estimation. Another prior improvement provides confidence sequences for online A/B tests in a variety of scenarios. However, that technique requires making certain assumptions about observed data (e.g., known lower/upper bounds, symmetry) which do not always hold in practice. In contrast, the disclosed framework works in situations where the prior method fails, such as unbounded observations like “time spent on a webpage,” “revenue,” and “days to next visit.”

The disclosed framework leverages the “anytime-valid inference” to extend typical A/B testing protocols for a sequential analysis. This extension allows an experimenter to (a) analyze results of an A/B test at any time including real-time, (b) conduct an A/B test without worrying about how many samples are needed to detect an effect that is valid, and (c) continue the experiment for any reason in the event that new data becomes available.

Therefore, if sample sizes are sufficiently large, the conclusions made from A/B tests are always valid regardless of how one chooses to start, stop, or continue an experiment. As such, data analysis is not limited to times after conclusion of an A/B experiment; instead, a platform that implements the framework can perform data analysis “on-the-fly” while new data are collected. Moreover, an A/B experiment can be stopped whenever the appropriate amount of data has been collected rather than needing to predetermine a sufficiently large sample size at the outset. Notably, it is difficult to predetermine how large of a sample size is required to detect a desired effect because that depends on the size of the effect. However, using the disclosed framework, the length (e.g., sample size) of the experiment adapts to the size of the effect.

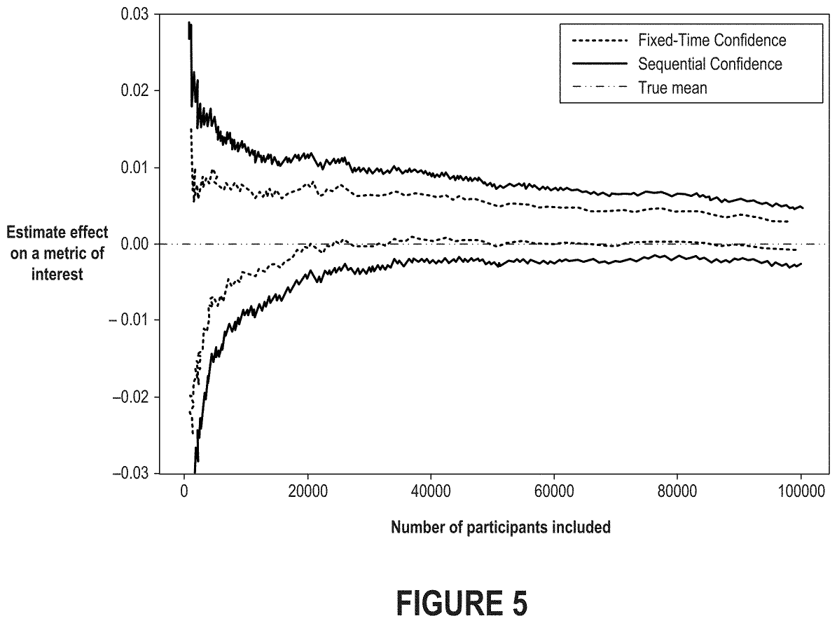

FIG. 5 is a graph that shows confidence intervals relative to a quantity of participants in an A/B test. As indicated earlier, to enable anytime analysis, the framework continuously updates a confidence interval to account for randomness of test data such that a valid conclusion of an effect on a metric of interest can be obtained anytime during the test. The horizontal axis represents the quantity of participants in the A/B test, which ranges from 0 to 100,000. The participants can include visitors of a website that are randomly selected to experience variants A/B of digital content on the website. The vertical axis represents an estimate effect of experiencing variants A/B on a metric of interest. An example of a metric of interest can includes a click-through, where the A/B test includes variants to increase the click-through.

As shown, the dash-dotted line represents the true mean (e.g., actual effect). In this example, the true mean is zero, which means that variants A/B are the same and there should be no effect on the metric of interest. In other words, all the participants were given the same experience (e.g., presented with the same web content) for the A/B test. As such, the results reflect the random nature of the A/B test rather than the effect on a metric of interest (because there was no difference between A/B).

The dotted-line represents the confidence interval for a typical A/B test, with upper and lower bounds. The solid line represents the confidence interval for an A/B test that implements the disclosed framework, also with upper and lower bounds. The position of the confidence intervals relative to the true mean indicates whether the A/B variants had a positive or negative effect on the metric of interest, or no effect at all. Specifically, a lower bound that is above the true mean indicates a positive effect, an upper bound that lies below the true mean indicates a negative effect, and a true mean between the upper and lower bounds indicates no effect.

In the illustrated example, the confidence interval of the typical A/B test shows an erroneous positive effect at different as the A/B test progresses, and correctly reflects no effect after about 90,000 participants. This example highlights the risk of prematurely examining results, which can lead an experimenter to make errant conclusions that an AB test had a positive effect on a metric of interest. This error is caused by the random variation of participants, which is not accounted for in typical A/B tests but is accounted for by the framework.

The disclosed framework accounts for random variations and conditions data of A/B tests such that valid results are available during anytime analysis. That is, the framework allows for sequential analysis or anytime-valid inference in A/B testing so that an experimenter no longer needs to wait an excessive time to obtain reliable results based on a predetermined number of participants. For example, the true mean of the graph in FIG. 5 lies between the bounds of improved confidence intervals throughout the entirety of sample size of participants. Hence, an experimenter can analyze the results of the A/B test and obtain a valid conclusion about the effect (e.g., positive, negative, none) at times before the A/B test is complete.

Thus, the disclosed framework conditions confidence intervals to account for past randomness such that results always include the true effect. In other words, the framework considers the sequence of random events and makes corrections that account for past events such that a next value is not affected by the past. As such, the experimenter avoids the chance error that leads to over-confidence by adjusting with wider confidence values, that are always true. As a result, the experimenter does not need to wait excessive times for a predetermined number of participants before analyzing results.

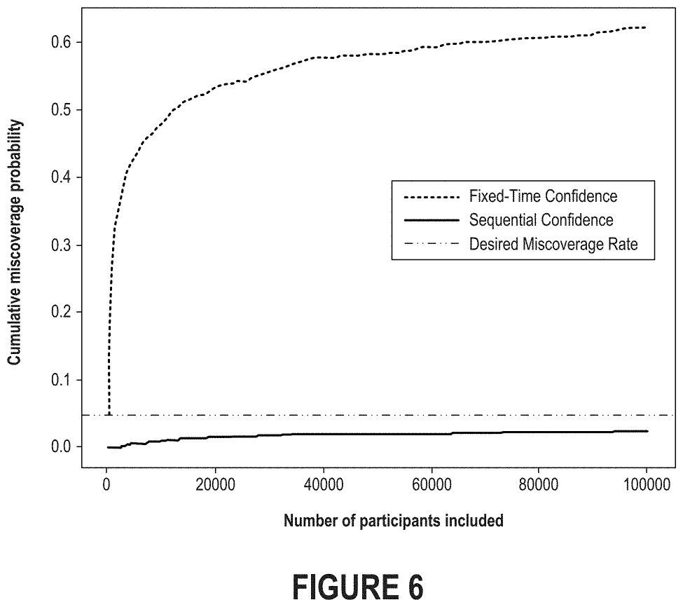

FIG. 6 is a graph showing cumulative miscoverage probabilities for fixed-time and sequential confidence intervals. The horizontal axis shows the number of participants in an A/B test and the vertical axis shows the cumulative miscoverage probability. The dash-dotted line represents the desired miscoverage rate. The dotted-line represents the fixed-time confidence interval of a typical A/B test, and the solid line represents the sequential confidence interval for an A/B test that implements the disclosed framework.

The graph illustrates the probability of obtaining a mistaken result over time. Specifically, the plot shows the probability of rejecting a null hypothesis when it is in fact true. As shown, the fixed-time confidence interval rejects the null hypothesis much higher than the desired miscoverage rate, with the probability that the null hypothesis will be rejected growing unbounded towards 1. On the other hand, the sequential confidence interval is always below the desired miscoverage rate, showing that the framework controls false positives to a desired level. In other words, for the conventional fixed-time confidence interval, the cumulative miscoverage probability increases as the number of participants increases. In contrast, the cumulative miscoverage probability for the sequential confidence interval remains below the desired miscoverage rate. Thus, the cumulative miscoverage probability remains near-zero as the number of participants increases.

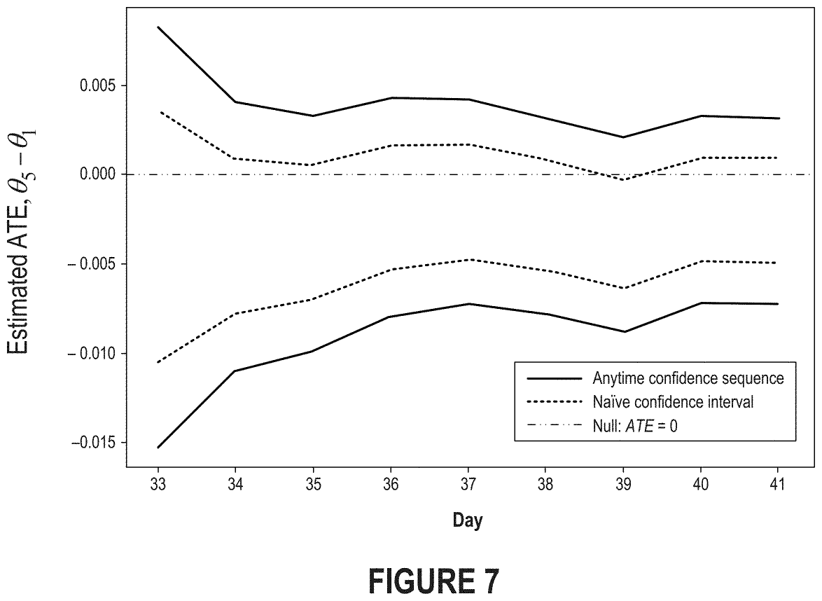

FIG. 7 is a graph of confidence interval ranges relative to a sample set of participants in an A/B test. The horizontal axis shows days of an A/B test and the vertical axis shows the ranges of the confidence intervals. The dash-dotted line represents the null value when ATE=0 (the true value). The dotted-line represents the Naïve confidence interval with upper and lower bounds, and the solid line represents the anytime confidence sequence with upper and lower bounds.

Specifically, the figure shows the relative performance of the Naïve confidence interval and the anytime confidence sequence on one set of streaming data. The data is generated under a null hypothesis; thus, the confidence limits should always include the true value (ATE=0). However, the Naïve confidence interval fails to do that, with the upper limit falling below the Null line, leading to rejection of the null hypothesis. On the other hand, the anytime confidence sequence includes the true value over the horizon of the test. That is, the null value remains between the upper and lower bounds for the anytime confidence sequence whereas the upper bound of the Naïve confidence interval drops below the Null value. Hence, the conventional Naïve confidence interval shows that the A/B test fails whereas the anytime confidence sequence remains valid.

Computing System

FIG. 8 is a block diagram illustrating an example of a computing system 800 in which at least some operations described herein can be implemented. For example, some components of the computing system 800 may be hosted on a computing device (e.g., computing device 100) of an optimization platform (e.g., optimization platform 302).

The computing system 800 may include one or more central processing units (also referred to as “processors”) 802, main memory 806, non-volatile memory 810, network adapter 812 (e.g., network interface), video display 818, input/output devices 820, control device 822 (e.g., keyboard and pointing devices), drive unit 824 including a storage medium 826, and signal generation device 830 that are communicatively connected to a bus 816. The bus 816 is illustrated as an abstraction that represents one or more physical buses and/or point-to-point connections that are connected by appropriate bridges, adapters, or controllers. The bus 816, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

The computing system 800 may share a similar computer processor architecture as that of a personal computer, tablet computer, mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computing system 800.

While the main memory 806, non-volatile memory 810, and storage medium 826 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 828. The term “machine-readable medium” and “storage medium” shall also be taken to include any medium that is capable of storing, encoding, or carrying a set of instructions for execution by the computing system 800.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in a computing device. When read and executed by the one or more processors 802, the instruction(s) cause the computing system 800 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 810, floppy and other removable disks, hard disk drives, optical disks (e.g., Compact Disk Read-Only Memory (CD-ROMS), Digital Versatile Disks (DVDs)), and transmission-type media such as digital and analog communication links.

The network adapter 812 enables the computing system 800 to mediate data in a network 814 with an entity that is external to the computing system 800 through any communication protocol supported by the computing system 800 and the external entity. The network adapter 812 can include a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 812 may include a firewall that governs and/or manages permission to access/proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall may additionally manage and/or have access to an access control list that details permissions including the access and operation rights of an object by an experimenter, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc. Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A computer-implemented method comprising:
executing, by a test module, a framework configured to optimize a metric of interest for a website in accordance with an A/B test including two variants of digital content presented to participants on respective instances of the website;
dynamically determining, by a confidence module, a sequence of confidence intervals while generating test data including an indication of an effect on the metric of interest based on interactions of the participants with the instances of the website,
wherein each next confidence interval accounts for randomness of past test data such that a true effect on the metric of interest is bounded by the sequence of confidence intervals throughout the A/B test; and
enabling, by an analysis module, anytime analysis of the test data before the A/B test is complete,
wherein an estimate of the effect on the metric of interest is bounded by the sequence of confidence intervals throughout the A/B test.

2. The computer-implemented method of claim 1 further comprising, prior to dynamically determining the sequence of confidence intervals:
instantiating, by an optimization module, the framework configured to optimize the metric of interest for the website; and
generating, by an estimation module, test data including the estimate of the effect on the metric of interest based on the interactions of the participants with the instances of the website.

3. The computer-implemented method of claim 1 further comprises:
causing, by a user interface module, display of a graphical user interface (GUI) including a visualization of the test data before the A/B test completes.

4. The computer-implemented method of claim 1, wherein dynamically determining the sequence of confidence intervals comprises:
obtaining the sequence of confidence intervals approximating a scaled Wiener process.

5. The computer-implemented method of claim 1, wherein dynamically determining the sequence of confidence intervals comprises:
obtaining the sequence of confidence intervals based on a stochastic process.

6. The computer-implemented method of claim 1, wherein generating the test data comprises:
estimating the effect based on bounded or unbounded interactions by the participants with the instances of the website including the variants of the digital content.

7. The computer-implemented method of claim 6, wherein a bounded interaction includes a click event or a conversion event.

8. The computer-implemented method of claim 6, wherein an unbounded interaction includes a time duration spent on the website or times between visits to the website.

9. The computer-implemented method of claim 1, wherein enabling the anytime analysis comprises:
enabling observation of a portion of total test data without pausing the A/B test.

10. The computer-implemented method of claim 1 further comprising:
updating the A/B test while executing the A/B test; and
determining each next confidence interval of the sequence of confidence intervals based on the updated A/B test such that the true effect remains bounded by subsequent confidence intervals.

11. The computer-implemented method of claim 10, wherein updating the A/B test comprises:
adding participants to the A/B test; and
adapting the determination of the sequence of confidence intervals based on the additional participants.

12. The computer-implemented method of claim 1, wherein the A/B test includes a predetermined quantity of the participants to complete the A/B test.

13. The computer-implemented method of claim 1, wherein the A/B test includes an undetermined quantity of the participants to complete the A/B test.

14. The computer-implemented method of claim 1, wherein enabling the anytime analysis comprises:
determining a positive effect or negative effect on the metric of interest at a point in time before completing the A/B test.

15. A non-transitory computer-readable medium with instructions stored thereon that, when executed by a processor, cause the processor to:
instantiate an A/B test configured to optimize a metric of interest related to a website including A/B variants presented to participants;
execute the A/B test by presenting the A/B variants on instances of the website to randomly selected subsets of the participants;
continuously determine confidence intervals that span the A/B test,
wherein a true effect on the metric of interest is bounded by the confidence intervals throughout the A/B test; and
enable an anytime analysis of test data as the A/B test is ongoing,
wherein the test data is indicative of an estimate effect on the metric of interest based on the A/B test, and
wherein the estimate effect is bounded by the confidence intervals throughout the A/B test.

16. The non-transitory computer-readable medium of claim 15, wherein the processor is further caused to:
determine a positive effect or a negative effect on the metric of interest.

17. The non-transitory computer-readable medium of claim 15, wherein the processor is further caused to:
generate the estimate effect based on unbounded interactions by the participants with the A/B variants.

18. The non-transitory computer-readable medium of claim 17, wherein the unbounded interactions include time periods spent by the participants on the website or times between visits by the participants to the website.

19. An optimization platform comprising:
a processor; and
memory containing instructions that, when executed by the processor, cause the optimization platform to:
process a controlled experiment configured to optimize a metric of interest by presenting instances of a website to a predetermined quantity of participants,
wherein each instance of the website includes one of two variants of digital content,
wherein the instances of the website are presented to the participants over a time period that is proportional to the predetermined quantity of the participants;
continuously generate test data throughout the controlled experiment,
wherein the test data is indicative of either a positive effect or a negative effect on the metric of interest;
dynamically determine a sequence of confidence intervals during the time period by conditioning next test data based on randomness of past test data,
wherein a true effect and an estimate effect are both bounded by the sequence of confidence intervals throughout the controlled experiment; and
cause display of an output indicative of either the positive effect or the negative effect at any point in time before completing the controlled experiment.

20. The optimization platform of claim 19, wherein the controlled experiment corresponds to an A/B test and the variants of digital content correspond to A/B variants.
